(19) United States
(12) Patent Application Publication
(10) Pub. No.: US 2006/0196909 A1
(43) Pub. Date: Sep. 7, 2006

(54) Novel device

(76) Inventors: Frederick B. Hadtke, King of Prussia, PA (US); Michael J. LaRocca, King of Prussia, PA (US); Lawrence M. Whalen Jr., King of Prussia, PA (US)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 10/553,081

(22) PCT Filed: Apr. 5, 2004
(86) PCT No.: PCT/US04/10365

§ 371 Date: Oct. 11, 2005

Related U.S. Application Data
(60) Provisional application No. 60/462,212, filed on Apr. 11, 2003.

(51) Int. Cl. B26F 3/02

(52) U.S. Cl. 225/39

(57) ABSTRACT

A dental floss container (20) comprises a base wall (21) and a side wall (22) extending upwardly from the periphery of the side wall (21) to define an open-topped compartment (23) for a spool of dental floss. The side wall (22) extends downwardly below the base wall (21) as a peripheral skirt (25), having a lower edge (26) of the skirt formed into a closure engagement part being a conventional snap-fit part which can snap-fit engage with the ledge of a toothpaste cap. The floss container (20) has a hinged lid (30) for the open-topped compartment (23).

### FIELD OF THE INVENTION

This invention relates to a novel device being a dispenser for dental floss, in particular such a dispenser being mountable on a toothpaste tube closure.

### BACKGROUND OF THE INVENTION

The concept of a toothpaste tube upon which is mounted a dental floss dispenser is known, for example U.S. Pat. No. 4,428,389, discloses a dental floss compartment which is engageable with the closure of a toothpaste tube, and which itself refers to earlier publications. U.S. Pat. No. 5,732,722 discloses an integrally moulded dental floss compartment and toothpaste tube closure. U.S. Pat. No. 4,797,783, U.S. Pat. No. 5,979,706, WO 01/13816, GB-A-2 333 276 also disclose similar concepts. U.S. Pat. No. 4,827,951 discloses a dental floss dispenser mounted on a pump dispenser of toothpaste, in which the top cover cap of the pump dispenser is provided with a peripheral mounting for the lower skirt of the floss dispenser.

There still remains room for improvement and optimisation of such dispensers and it is an object of this invention to provide an improved dispenser of this type, and to further improve dental floss dispensers generally.

### SUMMARY OF THE INVENTION

According to this invention a dental floss dispenser is provided, comprising;

a closure for a container of an extrudible dentrifice having an upper engagement part,

a container for dental floss comprising a base wall and a side wall extending upwardly from the periphery of the side wall to define an open-topped compartment for a spool of dental floss,

a closure engagement part on a lower surface of the container able to engage with the engagement part of the closure to thereby attach the compartment, the engagement part of the closure and the closure engagement part being shaped so that the respective engagement parts engage only in a single orientation,

a lid for the open-topped compartment integrally made with the side wall and integrally hinged thereto so that the lid can move about the hinge into a closing relationship with the open topped compartment,

an axle suitable to rotatably mount a spool of dental floss thereon projecting from one of said base wall or said lid and the other of the lid or base wall having an axle engagement part thereon, the axle having an engagement part at its end remote from respectively said lower wall or lid such that when the lid is hinged into a closing relationship with the compartment the axle engagement part and the engagement part of the axle engaging to hold the lid in the closed relationship,

an aperture in said side wall through which dental floss within the compartment may pass, the lid comprising an obstructer part which partly closes the aperture when the lid is in its closing relationship with the compartment,

a floss-cutting blade mounted on the compartment adjacent the outer surface of the side wall, the floss-cutting blade having a cutting edge and an opposite edge defining a blade axis between them, and defining a floss path between the aperture and the cutting edge,

a bridge part between the aperture and the cutting blade into contact with which the floss is brought when the floss is taut between the aperture and the cutting blade, a part of the outer surface of the side wall between the bridge part and the cutting blade having a concave profile relative to a line between the bridge part and the cutting blade,

the blade being mounted such that the cutting edge is further from the aperture than the opposite edge and the blade axis is aligned at an angle 0-45° to the floss path,

a cover integrally made with the lid and integrally hinged thereto so that the cover can move about the hinge into a covering relationship with the aperture and blade.

### DETAILED DESCRIPTION OF THE INVENTION

Herein the terms “upper” and “lower” and related directional terms relate to the direction between the closed lower end of a toothpaste container such as a toothpaste tube or pump, and the upper end at which the dispensing nozzle and closure of such a tube or pump is conventionally provided is located.

Preferred embodiments of the dispenser will now be described.

Preferably the closure and the compartment are made of an injection mouldable plastics material such as polypropylene, polyacrylate or polymethacrylate, or similar plastics material.

Preferably the closure is engageable with a dispensing opening of a toothpaste tube. Preferably the closure comprises an externally generally cylindrical body mountable on a toothpaste tube, incorporates a dispensing nozzle for the toothpaste, and incorporates an upper closure part e.g. a flip-top part which can be moved into a closing relationship with the nozzle. Preferably the body is integrally made with such a closure part, for example the closure part and body may be linked by an integral hinge. The closure part and body may be provided with engagement parts to enable the closure part to be securely but removeably engaged with the body part in the closing relationship with the nozzle. The use of such a flip-top closure part in combination with a cylindrical body part allows the closure part to have a wide upper surface facilitating the engagement of the container thereto, and with such a construction the upper engagement part of the closure may comprise a peripheral lip or ledge part around this upper surface with which the compartment may engage.

The container for dental floss is also preferably of a generally cylindrical outer shape, e.g. aesthetically matching the outer profile of the closure. Consequently in such a construction the base wall may be generally planar and perpendicular to the upper-lower direction of a toothpaste tube upon which the dispenser is mounted, with the side wall extending generally in this upper-lower direction. The open top may be bounded by a rim defined by an upper edge of the side wall.

The closure engagement part may comprise a skirt extending downwardly from the perimeter of the base wall and which can engage with the upper engagement pat of the closure e.g. the above-mentioned peripheral lip or ledge. These engagement parts may engage by a releasable snap-fit enabling the container to be removed and/or replaced.

The engagement part of the closure and the closure engagement part may be shaped so that the respective engagement parts engage only in a single orientation by means of the above mentioned skirt having a lower edge which is shaped to mate with a corresponding upward facing surface of the engagement part of the closure. For example the skirt may have a lower edge which undulates in its displacement in the up-down direction around its periphery, for example in a generally sinusoidal curve.

Suitably the lid is generally planar perpendicular to the upper-lower direction and of a shape in plan viewed down this direction which corresponds to the cross section of the upper edge of the side wall. The integral hinge may be a known type of plastics film or live hinge.

The lid and side wall may be respectively provided with engagement features, e.g. snap-fit engagement features, to enable the lid and side wall to be securely held together in their closed relationship.

However preferably the axle also provides a closure means for the lid and compartment as described following. The axle preferably extends upwardly within the compartment from the upper surface of the base wall and is integrally made, e.g. moulded, with the base wall. The axle engagement part is consequently in such a construction on the lower surface of the lid. The axle may have an engagement part at its end remote from the base wall with a corresponding snap-fit engagement part on the lower surface of the lid. For example the axle may have a socket at its end remote from the base wall, with which a plug part engages in a male snap-fit manner when the lid is hinged into its closing relationship with the compartment, to hold the lid in the closed relationship. Alternatively the axle may have an engagement part at its end remote from the base wall which engages in a male manner with a socket on the lower surface of the lid. This construction has the advantage that the axle can be made relatively structurally strong so as to support the lid against compressive forces tending to distort the lid. This can be useful during automatic assembly of the dispenser when the lid is pressed down onto the top of the compartment and a compressive force is applied to the lid to close it.

A spool of dental floss may be mounted on the axle so as to be rotatable about a rotation axis parallel to the upper-lower axis, to thereby unwind the spool from the axle. Typically such a spool comprises a toroidal member with an axial hole through which the axle is threaded when the spool is mounted thereon. In a preferred embodiment the axle and the inner surface of the hole have parts which frictionally engage to hinder free relative rotation of the spool on the axle. For example the axle may be cylindrical and may have frictionally engaging parts extending outwardly from its circular perimeter to frictionally engage with the inner surface of the hole, for example plural, preferably at least three, fins extending outwardly from the perimeter, e.g. radially, tangentially or parallel to a radius. Alternatively for example the hole may be cylindrical and may have frictionally engaging parts extending inwardly from its circular perimeter to engage with the axle, for example plural, preferably at least three, fins extending inwardly from the perimeter, e.g. radially, tangentially or parallel to a radius. By hindering free rotation of the spool unintended unwinding of floss may be prevented, which might otherwise result in jamming of the spool.

Preferably the side wall is generally circular in cross section across its upper-lower axis to define a cylindrical compartment, but with a segment of an upper part of the side wall deviating from circular and generally running along a chord of the circular and the aperture being provided through this segment of the side wall. By this construction the above-mentioned cover may have a part circular cross section so that when the cover is in its covering relationship with the aperture the cover and side wall together have the substantially circular cross section. In such a construction a cavity may be formed between the inner surface of the cover and the segment of the side wall.

The aperture preferably comprises a slot in this segment, elongate in the upper-lower direction and open at its upper end, and the obstructer part may comprise a wall part integrally made with the lid which fits into or partly close such a slot to partly close the aperture when the lid is in its closing relationship with the compartment. Such a construction provides the possibility that the floss can be easily threaded into the aperture by inserting the floss at the upper open end of the slot, then the lid can be closed such that the obstructer part functions to leave a residual aperture just large enough for the floss. This can be an advantage if the floss is a so-called “expanding floss” which expands on contact with moisture so that it is desirable to reduce the likelihood of moisture entering the compartment through the aperture.

The cover integrally made with the lid and integrally hinged thereto may be integrally injection moulded with both the lid and the side wall of the container. The cover and container, e.g. the side wall are preferably provided with snap-fit engagement parts to retain the cover securely but easily removeably in its covering relationship.

The bridge part may comprise a wing wall, integrally made with the side wall, e.g. with the segment, preferably extending perpendicularly to a diameter of a cylindrically sectioned compartment, and parallel to the upper-lower direction, and having an edge remote from the side wall. The part of the outer surface of the side wall which has a concave profile relative to the floss path enables a user of the dispenser to get a finger or finger nail into the concavity so created and so between the floss and the side wall. When floss is drawn from the aperture over the remote edge of this bridge part, the floss path consequently takes the floss to a point remote from the region of the side wall immediately adjacent to the aperture, consequently deepening the concave profile relative to the floss path.

The floss-cutting blade may be a generally conventional small metal leaf, for example made integrally with a mounting part to enable the blade to be mounted on a corresponding mounting on the side wall, e.g. a mounting bracket on the segment. Suitably the blade may be mounted with a lower end of the blade adjacent to the side wall e.g. to the segment, and with an upper end more distant from the side wall than the lower end so that the upper-lower axis of the blade leans at an acute angle e.g. 5-30° angle to the upper-lower axis. This enables a user to easily insert the floss between the blade and the sidewall. The blade is mounted such that the cutting edge is further from the aperture than the opposite edge and the blade axis between these edges is aligned at an angle 0-45° to the floss path. This alignment advantageously allows the residual end of the floss, after it has been cut, to be held by the cutting edge of the blade in compression between the blade and the side wall.

The above mentioned cavity formed between the inner surface of the cover and the segment of the side wall suitably covers the aperture, bridge and blade and any residual thread of floss extending between the aperture and a cut end of the floss held by the cutting edge of the blade in compression between the blade and the side wall, thereby protecting the floss and the blade from damage or contamination, and protecting persons such as the user etc. from injury from the blade.

The above disclosure of the dental floss dispenser also relates to features which appear to be novel and inventive per se in a dental floss dispenser.

Therefore in a further aspect of the invention a dental floss dispenser is provided, comprising a container for a spool of dental floss provided with an axle suitable to rotatably mount a spool of dental floss thereon, the spool comprising a toroidal member with an axial hole through which the axle is threaded when the spool is mounted thereon, the axle and the inner surface of the hole having parts which frictionally engage to hinder free relative rotation of the spool on the axle.

In a further aspect of this invention a dispenser for dental floss is provided, comprising a container for dental floss comprising a wall, an aperture in the wall through which dental floss within the compartment may pass, and an obstructer part which partly closes the aperture.

In a further aspect of this invention a dispenser for dental floss is provided, comprising a container for dental floss comprising a wall, an aperture in the wall through which dental floss within the compartment may pass, a floss-cutting blade mounted on the compartment adjacent the outer surface of the side wall, the floss-cutting blade having a cutting edge and an opposite edge defining a blade axis between them, and defining a floss path between the aperture and the cutting edge, the blade being mounted such that the cutting edge is further from the aperture than the opposite edge and the blade axis is aligned at an angle 0-45° to the floss path.

In a further aspect of this invention a dispenser for dental floss is provided, comprising a container for dental floss comprising a base wall and a side wall extending upwardly from the periphery of the side wall to define an open-topped compartment for a spool of dental floss,

an axle suitable to rotatably mount a spool of dental floss thereon projecting from one of said base wall or said lid and the other of the lid or base wall having an axle engagement part thereon, the axle having an engagement part at its end remote from respectively said lower wall or lid such that when the lid is hinged into a closing relationship with the compartment the axle engagement part and the engagement part of the axle engaging to hold the lid in the closed relationship,

the axle supporting the lid against compressive forces tending to distort the lid.

Preferred embodiments of these further aspects of the invention are as discussed above.

The invention will now be described by way of example only with reference to the following drawings which show:

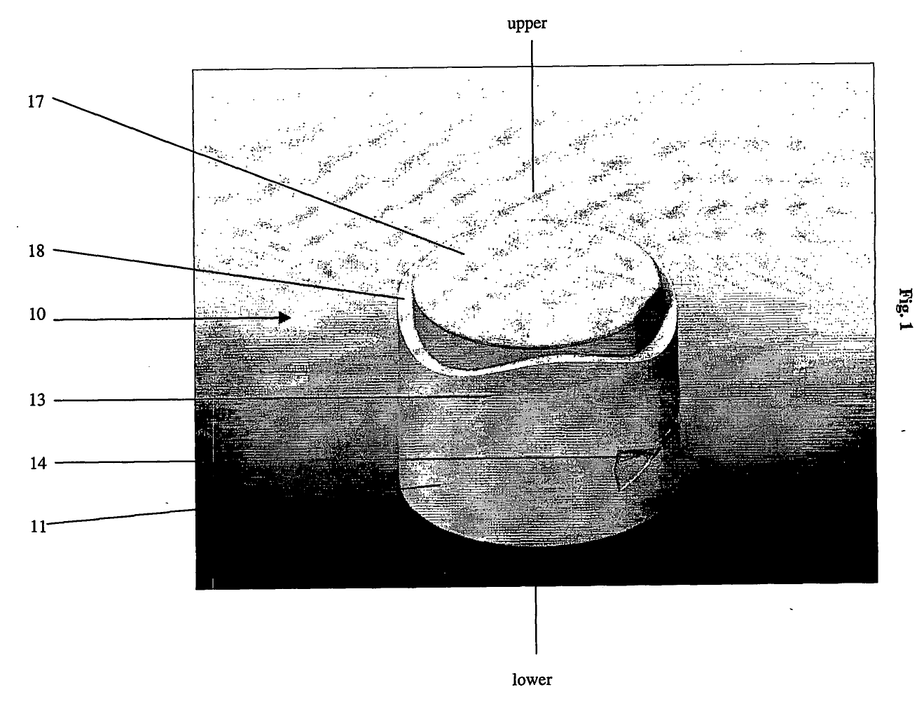

FIG. 1 A perspective view of a toothpaste tube closure in a closed configuration.

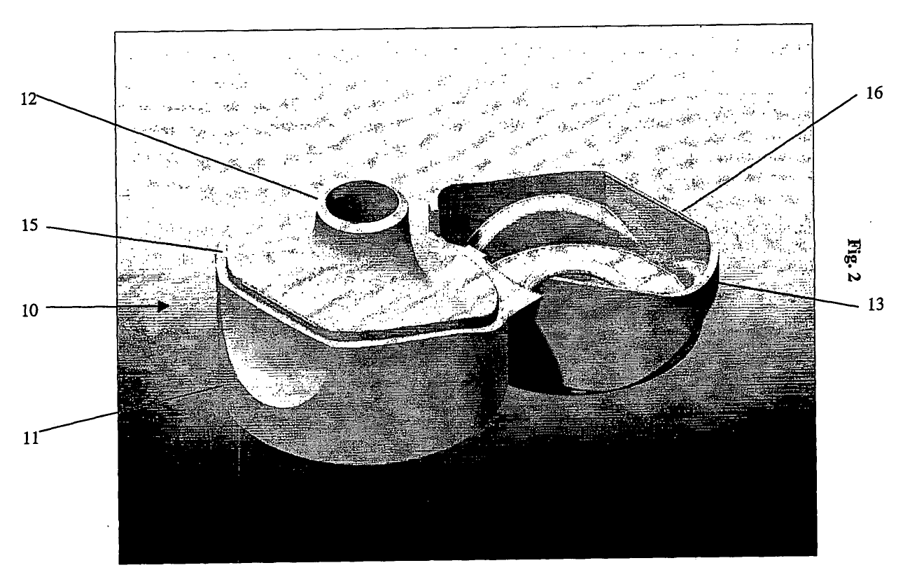

FIG. 2 A perspective view of the toothpaste tube closure of FIG. 1 in an open configuration.

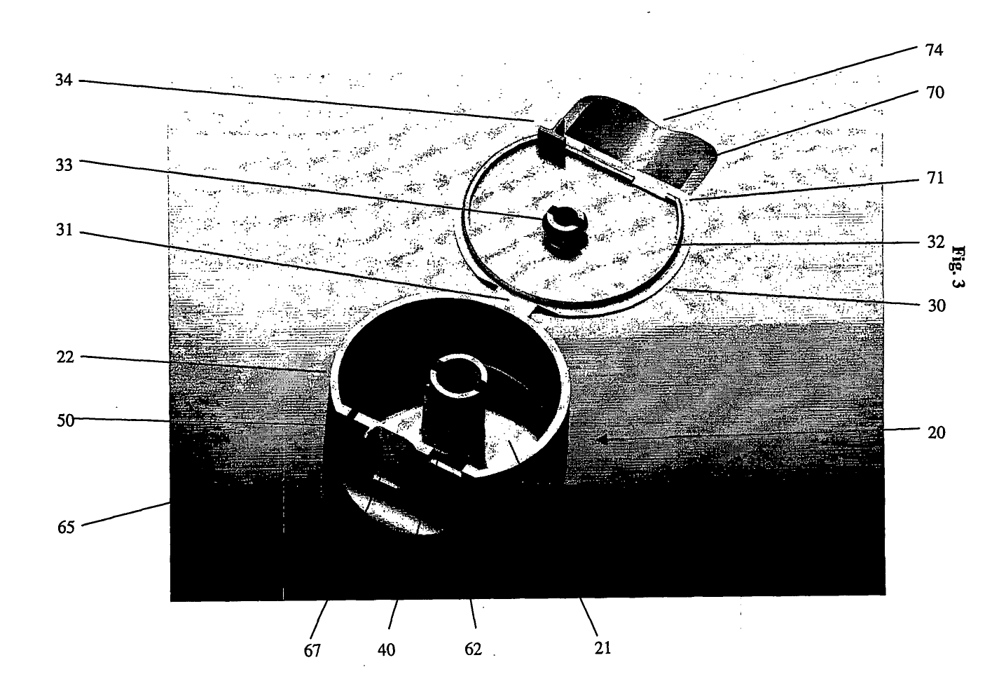

FIG. 3 A perspective view of a dental floss container.

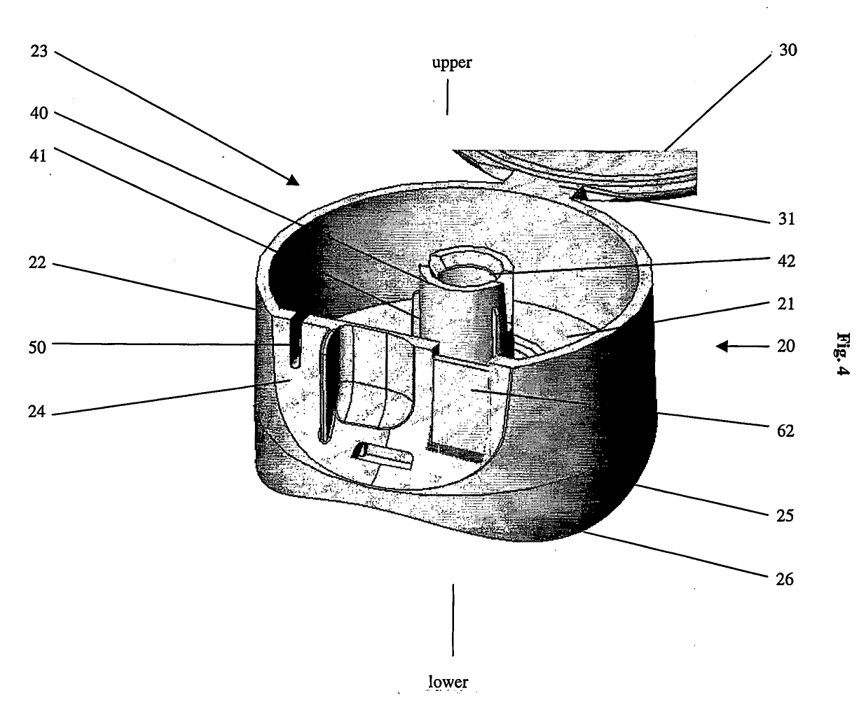

FIG. 4 A perspective view of the container of FIG. 3 showing more internal detail.

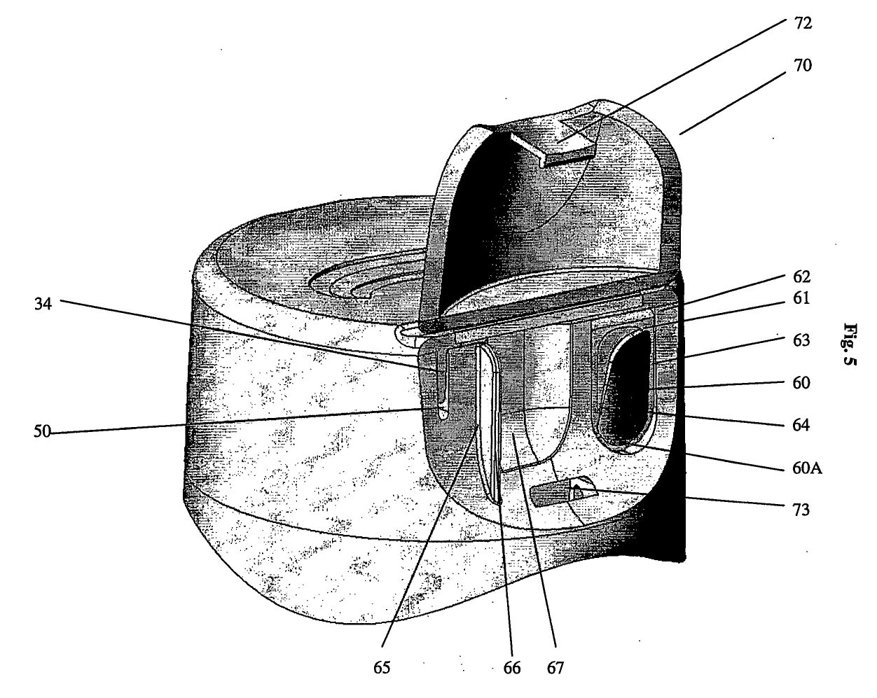

FIG. 5 A perspective view of the container of FIG. 3 in a closed configuration with the dental floss cutting components shown.

### LIST OF PARTS SHOWN IN FIGURES

10 toothpaste tube closure (overall)
11 lower generally cylindrical body
12 dispensing nozzle for toothpaste
13 an upper closure part
14 integral hinge
15, 16 snap-fit engagement parts
17 upper surface
18 peripheral ledge part
20 dental floss container
21 base wall
22 side wall
23 open-topped compartment for a spool of dental floss
24 segment of upper part of side wall
25 peripheral skirt
26 lower edge of skirt
30 lid for compartment
31 film hinge
32 ridge
33 male snap fit engagement part
34 obstructer part
40 axle for spool of dental floss
41 fins
42 female snap fit engagement part
50 aperture
60 floss-cutting blade
60A ower end of blade 60
61 mounting part of blade
62 mounting part of side wall
63 sharp cutting edge
64 opposite edge
65 bridge part.
66 edge of the bridge part
67 concave profile of wall
70 cover
71 integral film hinge
72 snap-fit engagement part
73 snap fit engagement part
74 notch

For clarity in FIGS. 1-5 the upper-lower direction is indicated.

Referring to FIG. 1, a closure for a container of an extrudible dentrifice is shown overall 10. This is made integrally of a plastics material, and comprises a lower generally cylindrical body 11 which is engageable in a conventional manner with a threaded nozzle (not shown) of a conventional toothpaste tube (not shown). As seen in its open configuration FIG. 2 the closure 10 incorporates a dispensing nozzle 12 for the toothpaste. The closure 10 incorporates an upper closure part 13 being a flip-top part which can be moved into a closing relationship as shown in FIG. 1 with the nozzle 12. The body 11 is integrally made with the closure part 13, the closure part 13 and body 11 being linked by an integral hinge 14. The closure part 13 and body 11 are provided with conventional snap-fit engagement parts 15, 16 to enable the closure part 13 to be securely but removeably engaged with the body part 11 in the closing relationship with the nozzle 12. The closure part 13 has a wide upper surface 17 around which there is a peripheral ledge part 18. This ledge part 18 enables engagement therewith of the dental floss container 20 which will now be described.

Referring to FIGS. 3, 4 and 5 the dental floss container 20 generally is shown in an open configuration. The container 20 comprises a base wall 21 and a side wall 22 extending upwardly from the periphery of the side wall 21 to define an open-topped compartment 23 for a spool of dental floss (not shown). This compartment 23 is generally cylindrical but a segment 24 of an upper part of the side wall 22 deviates from circular and generally runs along a chord of the circular.

The side wall 22 extends downwardly below the base wall 21 as a peripheral skirt 25, having a lower edge 26 of the skirt formed into a closure engagement part being a conventional snap fit part (not shown) which can snap-fit engage with the ledge 18. The edge 26 and ledge 18 are shaped so that the engagement part at the lower edge 26 and the ledge 18 can snap-fit engage only in a single orientation. This is achieved as shown by the lower edge 26 undulating in its displacement in the up-down direction around its periphery in a generally sinusoidal curve, and as seen in FIG. 1 the ledge 18 undulating in a corresponding manner so that edge 26 and ledge 18 can only engage in this one orientation.

The container 20 also comprises a lid 30 for the open-topped compartment 23. This lid 30 is integrally made with the side wall 22 and is integrally hinged thereto by film hinge 31 so that the lid 30 can move about the hinge into a closing relationship with the open topped compartment. In FIGS. 3 and 4 the lid 30 is shown in the open relationship, and in FIG. 5 in the closed relationship with compartment 23. Around the periphery of the lid 30 is formed a ridge 32 which fits into the open top of compartment 23 to assist in forming a tight, generally secure seal between lid 30 and wall 22.

Integrally made with base wall 21 is an axle 40 suitable to rotatably mount a spool of dental floss (not shown) thereon. The axle 40 projects in the upper-lower direction. The axle 40 is generally cylindrical, with plural, as shown three, fins 41 extending radially outwardly from its perimeter. These fins 41 frictionally engage with a spool of floss mounted on the axle 40 to hinder free rotation of the spool and consequently any unintended unwinding of floss.

At the end of the axle 40 remote from base wall 21 is a snap fit engagement part 42, being a female socket. The lid 30 has a corresponding male snap fit engagement part 33 on its lower surface, so that when the lid is in its closed configuration as shown in FIG. 5 the engagement parts 42, 33 engage to hold the lid in the closed relationship.

The axle 40 is made sufficiently structurally strong against downward compressive forces that the axle 40 can support the lid 30 against compressive forces tending to distort the lid 30 when the lid 30 is in the closed configuration. It will be appreciated that during automatic assembly of the container 20, and/or its assembly to the closure 10, the lid 30 is pressed down onto the top of the compartment 23 and a compressive force is applied to the lid 30. The supporting axle 40 usefully supports the lid 30 against any distortion likely to result from such pressure.

In the segment 24 of the side wall 22 there is an aperture 50 through which dental floss (not shown) within the compartment 23 may pass from the interior of compartment 23 to the exterior, for use. The aperture 50 comprises a slot in the segment 24, elongate in the upper-lower direction and open at its upper end. Integrally formed on the lower surface of lid 30 is an obstructer part 34 comprising a small projection from this lower surface, being generally “T” shaped in cross section across the upper-lower direction axis. In the closed configuration of the lid 30, as shown in FIG. 5, the stem of the “T” fits downwardly into the slot 50 to partly close the aperture 50 when the lid 30 is in its closing relationship with the compartment 23, and the two arms of the “T” fit against the inner surface of the wall 24. As seen in FIG. 5 the stem of the obstructer part 34 partly closes the aperture 50 to leave only a small residual open part of the aperture 50.

A floss-cutting blade 60 is mounted on the segment 24 of the side wall. The floss-cutting blade 60 is a generally conventional small metal leaf and is made integrally with a mounting part 61 which can fit over a mounting part 62 of the segment 24 enabling the blade 60 to be mounted thereon. As seen in FIG. 5 the blade 60 is mounted with a lower end 60A of the blade adjacent to the side wall 24, and with its opposite upper end more distant from the side wall 24 than lower end 60A so that the upper-lower axis of the blade leans at an acute angle e.g. 5-30° angle to the upper-lower axis. The blade 60 has a sharp cutting edge 63 and an opposite edge 64 on either sides of the upper-lower axis of the blade 60, and as seen in FIG. 5 the blade 60 is mounted such that the cutting edge 63 is further from the aperture 50 than the opposite edge. A floss path is thereby defined between the aperture 50 and the cutting edge 63. It is seen in FIG. 5 that the blade axis between edges 63, 64 is aligned at an angle 0-45° to the floss path. A bridge part 65 made integrally with the segment 24 extends perpendicularly from the line of the segment 24, and is located on the floss path between the aperture 50 and the cutting edge 63. As floss is drawn from the aperture 50 by a user, is inserted between the segment 24 and blade 60 and is pulled taut, the floss comes into contact with the edge 66 of the bridge part 65 remote from wall 24. Between the bridge part 65 and the blade 60 the wall 24 has a concave profile at 67 relative to a line between the edge 66 of the bridge part 65 and the cutting edge 63. The above-mentioned alignment of the blade 60 advantageously allows the residual end of the floss (not shown), after it has been cut, to be held by the cutting edge 63 of the blade 60 in compression between the blade 60 and the side wall 24.

A cover 70 is integrally made with the lid 30 and is integrally hinged thereto by the integral film hinge 71. This enables the cover 70 to be moved about the hinge 71 into a covering relationship with the aperture 50 and blade 60. The cover 70 and side wall 22 are provided with respective snap-fit engagement parts 72, 73 enabling the cover 70 to be securely but removably engaged with the side wall 22 in its covering relationship.

In use, the dispenser is provided in the form of the closure 10 in position engaged with the nozzle of a toothpaste tube (not shown), and with the compartment 20 engaged therewith. An end of the dental floss (not shown) on a spool (not shown) threaded on axle 40 within compartment 23 extends from aperture 50, passes over bridge 65, and gripped between cutting edge 63 and wall 24, with the lid 30 and cover 70 in their closed configuration.

The user opens cover 70, a convenient notch 74 being provided at the lower end of cover 70 to allow the user to insert a thumb or finger nail to open the cover so that the container 20 is as shown in FIG. 5. The user then grips the floss (not shown), conveniently inserting a finger tip or nail between the floss and the wall 24 adjacent concavity 67. A suitable length of floss may then be drawn out of aperture 50 and inserted between blade 60 and wall 24. A pull on the part of the floss extending beyond the blade causes the cutting edge 63 to cut the floss for use. The cover 70 may then be closed and the floss used.

What is claimed is:

1. A dental floss dispenser, comprising;
a closure for a container of an extrudible dentrifice having an upper engagement part,
a container for dental floss comprising a base wall and a side wall extending upwardly from the periphery of the side wall to define an open-topped compartment for a spool of dental floss,
a closure engagement part on a lower surface of the container able to engage with the engagement part of the closure to thereby attach the compartment, the engagement part of the closure and the closure engagement part being shaped so that the respective engagement parts engage only in a single orientation,
a lid for the open-topped compartment integrally made with the side wall and integrally hinged thereto so that the lid can move about the hinge into a closing relationship with the open topped compartment,
an axle suitable to rotatably mount a spool of dental floss thereon projecting from one of said base wall or said lid and the other of the lid or base wall having an axle engagement part thereon, the axle having an engagement part at its end remote from respectively said lower wall or lid such that when the lid is hinged into a closing relationship with the compartment the axle engagement part and the engagement part of the axle engaging to hold the lid in the closed relationship,
an aperture in said side wall through which dental floss within the compartment may pass, the lid comprising an obstructer part which partly closes the aperture when the lid is in its closing relationship with the compartment,
a floss-cutting blade mounted on the compartment adjacent the outer surface of the side wall, the floss-cutting blade having a cutting edge and an opposite edge defining a blade axis between them, and defining a floss path between the aperture and the cutting edge,
a bridge part between the aperture and the cutting blade into contact with which the floss is brought when the floss is taut between the aperture and the cutting blade, a part of the outer surface of the side wall between the bridge part and the cutting blade having a concave profile relative to a line between the bridge part and the cutting blade,
the blade being mounted such that the cutting edge is further from the aperture than the opposite edge and the blade axis is aligned at an angle 0-45° to the floss path,
a cover integrally made with the lid and integrally hinged thereto so that the cover can move about the hinge into a covering relationship with the aperture and blade.

2. A dental floss dispenser, comprising a container for a spool of dental floss provided with an axle suitable to rotatably mount a spool of dental floss thereon, the spool comprising a toroidal member with an axial hole through which the axle is threaded when the spool is mounted thereon, the axle and the inner surface of the hole having parts which frictionally engage to hinder free relative rotation of the spool on the axle.

3. A dispenser for dental floss, comprising a container for dental floss comprising a wall, an aperture in the wall through which dental floss within the compartment may pass, and an obstructer part which partly closes the aperture.

4. A dispenser for dental floss, comprising a container for dental floss comprising a wall, an aperture in the wall through which dental floss within the compartment may pass, a floss-cutting blade mounted on the compartment adjacent the outer surface of the side wall, the floss-cutting blade having a cutting edge and an opposite edge defining a blade axis between them, and defining a floss path between the aperture and the cutting edge, the blade being mounted such that the cutting edge is further from the aperture than the opposite edge and the blade axis is aligned at an angle 0-45° to the floss path.

5. A dispenser for dental floss, comprising a container for dental floss comprising a base wall and a side wall extending upwardly from the periphery of the side wall to define an open-topped compartment for a spool of dental floss,
an axle suitable to rotatably mount a spool of dental floss thereon projecting from one of said base wall or said lid and the other of the lid or base wall having an axle engagement part thereon, the axle having an engagement part at its end remote from respectively said lower wall or lid such that when the lid is hinged into a closing relationship with the compartment the axle engagement part and the engagement part of the axle engaging to hold the lid in the closed relationship,
the axle supporting the lid against compressive forces tending to distort the lid.
